(19) United States
(12) Patent Application Publication
(10) Pub. No.: US 2013/0001839 A1
(43) Pub. Date: Jan. 3, 2013

(54) METHOD FOR PROTECTING THE VALVE OF A MOLTEN-METAL LADLE AND FACILITATING FREE OPENING THEREOF

(76) Inventor: James M. Britt, Birmingham, AL (US)

(21) Appl. No.: 13/387,417

(22) PCT Filed: Aug. 3, 2010
(86) PCT No.: PCT/US10/44228

§ 371 Date: Sep. 10, 2012

Related U.S. Application Data
(60) Provisional application No. 61/230,828, filed on Aug. 3, 2009.

(51) Int. Cl. B22D 41/08; C04B 35/462

(52) U.S. Cl. 266/45; 501/133; 501/99

(57) ABSTRACT

Spout-filling compositions and a method for protecting and facilitating free opening of a spout valve of a ladle are disclosed. The spout-filling compositions may comprise an iron-based ilmenite sand. More particularly, the compositions may comprise ilmenite sand in combination with a quartz and/or carbon black and/or chromite and zircon. The compositions described herein may be placed in a ladle to insulate the valve from molten metal.

### FIELD OF INVENTION

The present invention relates to a method and composition for protecting the opening valve of a ladle from molten metals and facilitating free opening of the valve and nozzle.

### BACKGROUND OF THE INVENTION

In the metal-casting industry the process of transporting molten metal from the primary processes where the metal chemistry is adjusted to its final form in the casting apparatus involves the use of a ladle. This ladle can vary in size but has as its primary components a metal shell with a refractory lining and an opening in the bottom of the lined shell. This opening is composed of a well block which contains an open cone which feeds a gate assembly. The opening is often referred to as a nozzle or spout and the gate assembly serves as a valve for releasing molten metal from the ladle through the nozzle/spout.

In practice, molten metal is poured into the refractory-lined shell and processed to the desired chemistry. The ladle is then transported to the caster. When the ladle is suitably positioned over the caster, the valve (gate assembly) is opened to release the molten metal into the caster. Because the valve region of the ladle is not fully protected by refractory lining, it is desirable to protect the valve and associated nozzle area from the damaging effects of molten metal and, further, facilitate free opening of the valve to release the molten metal.

### SUMMARY

In the present invention, a spout-filling composition comprising an iron-based ilmenite sand (more typically chemically known as iron titanate, iron titanium trioxide or iron titanium oxide, and having the chemical formula FeTiO₃) is placed in the bottom of a ladle prior to the placement of molten metal into the ladle to insulate the valve of the ladle from molten metal and facilitate free opening of the valve. The general formula for what is referred to as the “ilmenite group” of minerals is ATiO₃; where the A can be either iron, magnesium, zinc and/or manganese. When the term “ilmenite” alone is used as a noun it typically is meant to refer to the mineral alternatively known as iron titanate, iron titanium trioxide or iron titanium oxide, having the chemical formula FeTiO3.

In accordance with an aspect of one embodiment of the invention, the ilmenite sand is combined with quartz and used as a nozzle sand. In accordance with a further aspect, carbon black may be added to the sand composition.

According to another embodiment of the present invention, ilmenite sand is mixed with chromite and/or zircon and placed in a ladle to insulate the valve from molten metal. In accordance with an aspect of this embodiment, quartz is added to the ilmenite-chromite/zircon mixture. In accordance with an additional aspect of this embodiment carbon black is added to the composition.

According to another embodiment of the invention a Heavy Metal Concentrate (“HMC”) is placed in a ladle to insulate the valve from molten metal.

According to a further embodiment of the invention, HMC is mixed with a predetermined quantity of chromite and/or zircon and placed in a ladle to insulate the valve from molten metal. In a further aspect of this embodiment carbon black is added to the HMC-chromite/zircon mixture.

Other aspects, objects, features, and advantages of the present invention will become apparent to those skilled in the art upon reading the detailed description of embodiments thereof.

### DETAILED DESCRIPTION OF EMBODIMENTS OF THE INVENTION

While the specifications concludes with claims particularly pointing out and distinctly claiming the subject matter with is regarded as the present invention, the invention will now be described with reference to the following description of embodiments.

In one embodiment, a spot-filling, sand composition comprises the mineral ilmenite. The spout-filling composition of this first embodiment may additionally contain quartz. In a suitable formulation, up to about 80% by weight of ilmenite may be combined with up to about 20% by weight quartz. About +0.4% by weight carbon black may be added to the ilmenite-quartz mixture. A suitable formulation by weight and particle size is shown in a table below. This composition is placed in a ladle to fill the spout region thereof before molten metal is placed in the ladle.

In another embodiment, a spout-filling sand composition comprises ilmenite, chromite and/or zircon, quartz and, optionally, an additional quantity of carbon black. A suitable mixture contains about 70% by weight of a blend of the performance materials ilmenite and chromite and/or zircon, and about 30% by weight quartz of the appropriate particle size as to match the performance blend. About +0.4% by weight finely divided carbon may be added to the ilmenite-chromite/zircon mixture. A suitable formulation by weight and particle size is shown in a table below. This composition is placed in a ladle to fill the spout region before molten metal is placed in the ladle.

Of the ceramic raw materials used as ingredients, chromite and zircon are considered key performance ingredients of the spout-filling composition, and in a typical nozzle-sand mixture can account for as much as 60% to 70% of the weight of the spout-filling mass. Chromite and zircon are mined materials and are typically beneficiated to the degree necessary for optimum performance in the finished product. Thus, refined, beneficiated chromite and zircon are expensive ingredients. The nozzle-sand formulations of the invention eliminates or minimizes the use of chromite and zircon (and thus the cost associated therewith) while still providing an effective protective and opening agent for the opening valve of a ladle.

In an additional embodiment, a spout-filling composition comprises from about 50% to about 100% by weight of a Heavy Metal Concentrate (HMC) with the balance by weight made of the deficient performance ingredient (for example, chromite or zircon) which may be lacking or in insufficient quantity in the HMC. The term Heavy Metal Concentrate is used herein to refer to a composition containing one or more heavy metal substances in greater than minor trace quantity. The HMC contains one or more of the following minerals: chromite, zircon, ilmenite, magnetite, hematite, quartz, rutile in the 5% to 95% by weight of the HMC. About +0.4% by weight of finely divided carbon may be added to the HMC admixture described above. This composition is placed in a ladle to fill the spout region before molten metal is placed in the ladle.

The use of HMC allows the introduction of the key component ceramic materials without the full beneficiation (achieved through extraction processing) normally afforded these minerals. Additions of the fully beneficiated minerals may be required to produce the proper chemistry in the final composition. In a further embodiment, which may be considered a narrow refinement of the previous embodiment, a spout-filling composition comprises HMC combined with a predetermined quantity of chromite and/or zircon. A suitable mixture contains about 70% by weight HMC and about 30% by weight chromite and/or zircon. About +0.4% by weight of finely divided carbon may be added to the HMC admixture described above. A suitable formulation by weight and particle size is shown in a table below. This composition is placed in a ladle to fill the spout region before molten metal is placed in the ladle.

### Exemplary Formulations

| MATERIAL | % BY WEIGHT | PARTICLE SIZE |
|---|---|---|
| MIX #1 | | |
| Ilmenite | About 80 | 12 mesh by 150 mesh |
| Quartz | About 20 | 12 mesh by 150 mesh |
| Carbon black | About +0.4 | Minus 150 mesh |
| MIX #2 | | |
| Ilmenite | About 40 | 12 mesh by 150 mesh |
| Chromite or Zircon | About 30 | 12 mesh by 150 mesh |
| Quartz | About 30 | 12 mesh by 150 mesh |
| Carbon black | About +0.4 | Minus 150 mesh |
| MIX #3 | | |
| HMC | About 70 | 12 mesh by 150 mesh |
| Chromite or Zircon | About 30 | 12 mesh by 150 mesh |
| Carbon black | About +0.4 | Minus 150 mesh |

1. A spout-filling mass comprising up to about 80% by weight ilmenite and up to about 20% by weight quartz.

2. A spout-filling mass comprising up to about 40% by weight ilmenite, up to about 30% by weight of at least one of chromite and zircon and up to about 30% by weight of quartz.

3. A spout filing mass comprising from about 50% HMC to about 100% HMC.

4. A spout-filling mass comprising up to about 70% by weight HMC and up to about up to about 30% by weight of at least one of chromite and zircon.

5. The spout-filling mass of claim 1, comprising an additional about 0.4% by weight carbon black.

6. A method for protecting and facilitating free opening of a spout valve of a ladle comprising:
providing the spout-filling mass of claim 1, and
placing said spout-filling mass in a bottom of the ladle adjacent the valve.

7. The spout-filling mass of claim 2, comprising an additional about 0.4% by weight carbon black.

8. The spout-filling mass of claim 3, comprising an additional about 0.4% by weight carbon black.

9. The spout-filling mass of claim 4, comprising an additional about 0.4% by weight carbon black.

10. The spout-filling mass of claim 5, comprising an additional about 0.4% by weight carbon black.

11. A method for protecting and facilitating free opening of a spout valve of a ladle comprising:
providing the spout-filling mass of claim 2, and
placing said spout-filling mass in a bottom of the ladle adjacent the valve.

12. A method for protecting and facilitating free opening of a spout valve of a ladle comprising:
providing the spout-filling mass of claim 3, and
placing said spout-filling mass in a bottom of the ladle adjacent the valve.

13. A method for protecting and facilitating free opening of a spout valve of a ladle comprising:
providing the spout-filling mass of claim 4, and
placing said spout-filling mass in a bottom of the ladle adjacent the valve.

14. A method for protecting and facilitating free opening of a spout valve of a ladle comprising:
providing the spout-filling mass of claim 5, and
placing said spout-filling mass in a bottom of the ladle adjacent the valve.
